(19) United States
(12) Patent Application Publication
(10) Pub. No.: US 2010/0096773 A1
(43) Pub. Date: Apr. 22, 2010

(54) Syringe Body

(75) Inventor: Bart Gerard Boucherie, Izegem (BE)

Correspondence Address: LAW OFFICES OF STUART J. FRIEDMAN, 28930 RIDGE ROAD, MT. AIRY, MD, 21771, US

(73) Assignee: Firma G.B. Boucherie N.V., Izegem (BE)

(21) Appl. No.: 12/311,651

(22) PCT Filed: Oct. 9, 2007
(86) PCT No.: PCT/EP2007/008759

§ 371 Date: Nov. 9, 2009

(30) Foreign Application Priority Data
Oct. 9, 2006 (DE) 10 2006 047 670.0

(51) Int. Cl. B29C 45/14; B29C 45/76

(52) U.S. Cl. 264/277; 425/542

(57) ABSTRACT

A method of producing, by injection molding, a hollow cylindrical syringe body which is provided with a scale applied in the longitudinal direction. The scale is applied to a thin carrier film and the carrier film with the scale is inserted into the injection mold prior to the injection molding process.

The present invention relates to a method of producing, by injection molding, a hollow cylindrical syringe body and to a syringe body produced by means of this method. The syringe body is provided with a scale applied in the longitudinal direction. The invention further relates to an injection mold for producing a syringe body.

Syringes consist of a syringe body and a piston movable therein. In particular in the case of the so-called disposable syringes, the syringe body is made of a plastic material and is fabricated at low cost as a mass-produced article by injection molding. For dosage of the drug to be injected, the syringe body needs to be provided with a scale applied in the longitudinal direction.

The measurement scale may be applied by printing it on. Alternatively, the measurement scale may be glued onto the syringe body from outside. In either case, a work step is required following the injection molding process.

With syringes being mass-produced articles, there is a need for a method that allows syringe bodies to be provided with a scale without expense.

The present invention provides a method having the features of claim 1, in which a scale is first applied to a thin carrier film and the carrier film with the scale is inserted into the injection mold prior to the injection molding process. Printing on film is a well-mastered technique used to obtain a permanent print quickly. Insertion of the carrier film into the mold may be easily integrated into the molding process and is effected, for example, immediately after the respective previously fabricated syringe body has been removed from the mold.

Preferably, the shaping surface of the injection mold has an alignment structure incorporated therein with the aid of which the carrier film is accurately positioned. In a preferred embodiment, the alignment structure is a flat recess having a shape that corresponds to the outer contour of the carrier film, with the depth of the recess preferably amounting to a fraction of the thickness of the carrier film. This means that the inserted carrier film protrudes into the plastic composition during the injection molding process and is in this way securely held on the finished syringe body.

As an alternative, the shaping surface of the injection mold may have at least one stop incorporated therein which serves for alignment of the carrier film. This stop is preferably a step, so that the carrier film can be pushed until it comes to rest against this step.

In an advantageous embodiment, the carrier film is preformed prior to its insertion into the injection mold to adjust it to the inside radius thereof.

In injection molding the plastic material is injected in liquid form into the injection mold. The flow of liquid plastic material may secure the inserted carrier film against shifting during the injection process if the point of injection in relation to the carrier film is skillfully selected. The carrier film is preferably made to have an opening and the opening is arranged in alignment with the runner, so that during the injection process the plastic composition that is injected traverses the opening. The injected plastic composition will then flow around the core of the injection mold at first in a direction away from the carrier film and then builds up a pressure which presses the carrier film against the inner surface of the mold and thus fixes it in position.

Further advantages of the method according to the invention will be apparent from the description below of preferred embodiments with reference to the accompanying drawings, in which:

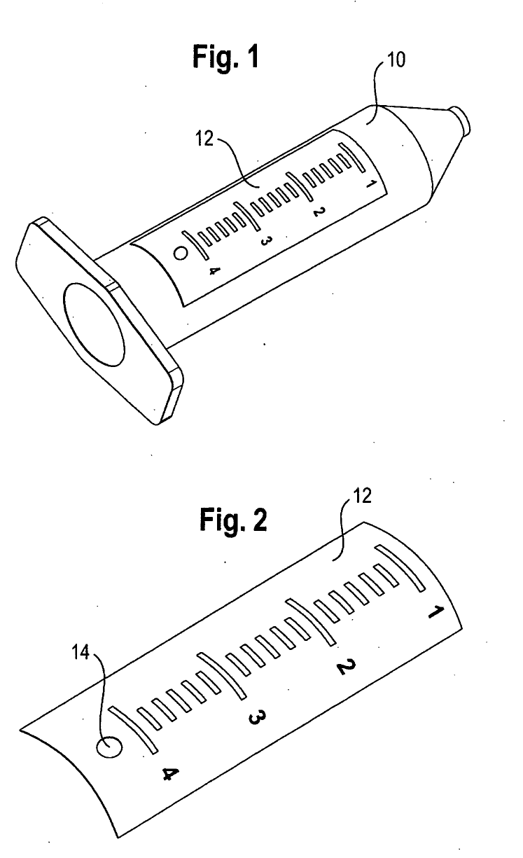

FIG. 1 shows a syringe body produced in accordance with the method according to the invention;

FIG. 2 shows a thin carrier film with a scale applied thereto;

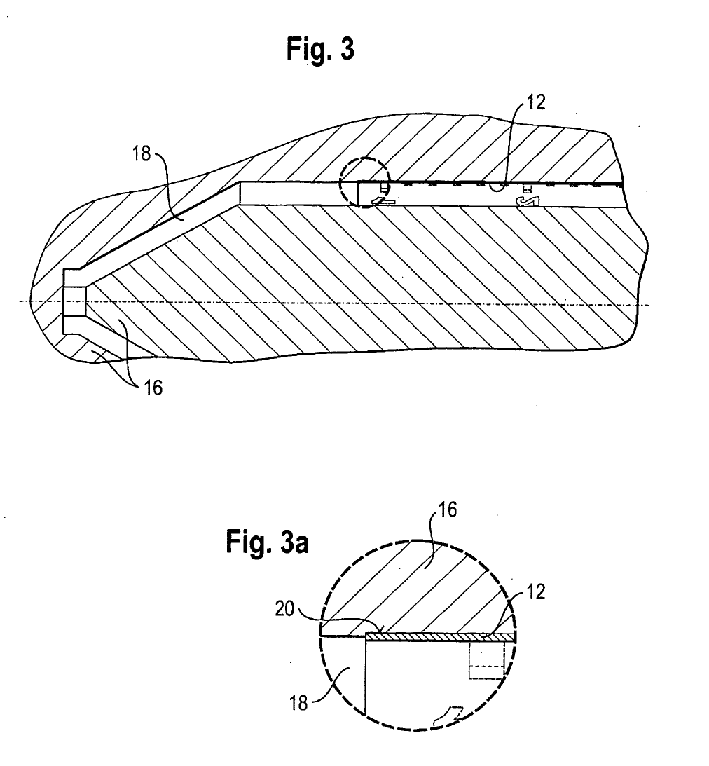

FIG. 3 shows a partial cross-section through an injection mold with a carrier film inserted in a recess;

FIG. 3a shows an enlarged detail of FIG. 3 for a better illustration of the recess;

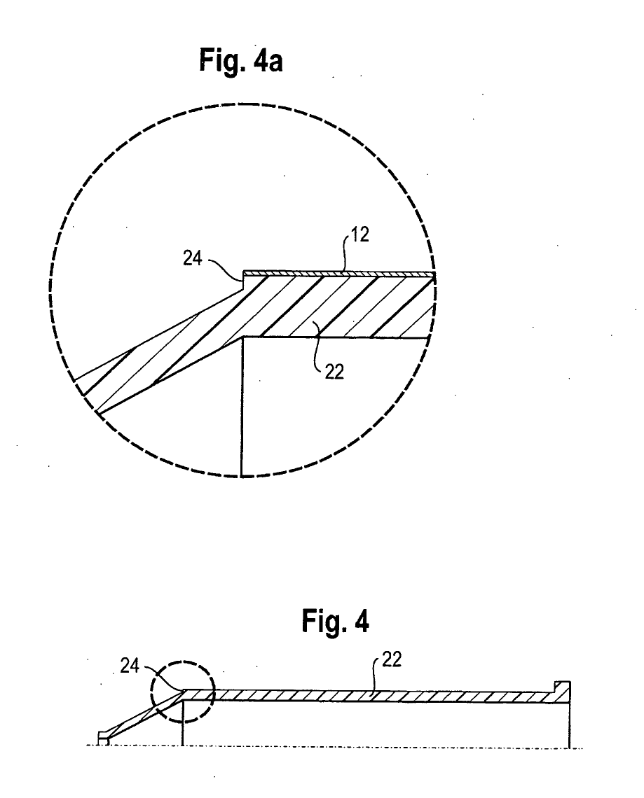

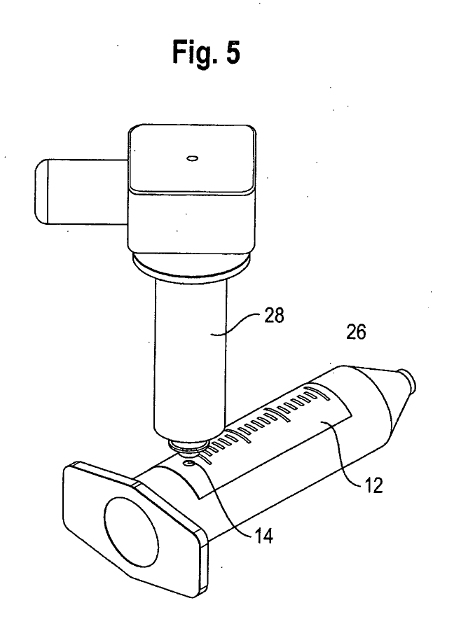

FIG. 4 shows a partial cross-section through a syringe body according to a further embodiment, with a carrier film contacting a stop;

FIG. 4a shows an enlarged detail of FIG. 4 for a better illustration of a step;

FIG. 5 shows a schematic illustration of the positioning of the injection nozzle in proportion to the finished syringe body.

FIG. 1 shows a syringe body 10 including a carrier film 12 having a scale applied thereto. The syringe body 10 is of a hollow cylindrical shape and has a conical taper on one side for a hypodermic needle to be fitted thereto. At the other end of the syringe body 10, a flange is shown which facilitates later handling of the syringe. The syringe body may take other shapes at its ends and may also, for example, have no flange; only the hollow cylindrical shape and the scale applied are of relevance to the invention. The width of the carrier film 12 amounts to roughly one third to one fourth of the circumference of the syringe body. The length of the syringe body amounts roughly to between 5 and 15 cm; accordingly, it has a diameter of roughly between 1 and 3 cm.

FIG. 2 shows the carrier film 12 with the scale already applied thereto, for example by screen printing. An opening 14 can be seen at one end, below the FIG. 4 on the scale. The significance of the opening 14 will be discussed further below. The carrier film 12 as illustrated has already been preformed so that it better fits snugly against the inner wall of an injection mold.

FIG. 3 shows part of a cross-section through an injection mold 16. A cavity 18 has the shape of the syringe body 10 to be produced. The carrier film 12, already inserted, can be seen. FIG. 3a shows an enlarged detail from FIG. 3. The upper part illustrates the section taken through the injection mold 16. The carrier film 12, likewise partly shown in section, is located in a recess 20. As can be seen in the enlarged detail view, it protrudes into the cavity 18 since the depth of the recess corresponds to only a fraction of the thickness of the carrier film 12.

FIG. 4 shows a section taken through a syringe body 22 of a different embodiment. Only in the enlarged detail view of FIG. 4a is the applied carrier film 12 visible. At the point at which the hollow cylindrical portion of the syringe body 22 makes a transition to a conical shape, a step 24 is provided. An edge of the carrier film 12 is in alignment with the step 24. The corresponding inverse step of the injection mold that is used for manufacturing the syringe body 22 serves as a stop for the carrier film 12 when the latter is inserted into the mold.

In addition to the recess 20 or the step 24, a suitable selection of the point of injection helps to prevent the carrier film 12, which does not cover the entire shaping surface of the injection mold, from being swept away or from shifting. FIG. 5 symbolically illustrates the preferred point of injection. An injection nozzle 28 is schematically illustrated above a syringe body 26, which may correspond to the syringe body 10 or the syringe body 22. For increased clarity, the injection mold in which the syringe body 26 is injection molded is not shown. As already mentioned in the description in relation to FIG. 2, the carrier film 12 has an opening 14 which is arranged in alignment with the runner of the injection nozzle 28 so that during injection molding the plastic composition that is injected traverses the opening 14. The opening 14 is disposed in the vicinity of the edge of the carrier film 12 facing the flange and substantially centrally with respect to the longitudinal edges of the carrier film 12. As a result, the flow conditions that develop in the hollow mold during injection molding will not cause the carrier film 12 to be swept away but, on the contrary, will even cause it to be pressed against the inner wall of the injection mold. The plastic composition that is injected under pressure will initially flow around the inside core and will at first fill the cavity located opposite the injection opening 14 and on the other side of the core to then fill up the cavity from both sides of the core toward the carrier film 12. The pressure building up in the process presses the carrier film 12 against the inner surface of the injection mold.

1. A method of producing, by injection molding, a hollow cylindrical syringe body which is provided with a scale applied in the longitudinal direction, comprising the steps of
applying the scale to a thin carrier film, and
inserting the carrier film with the scale into the injection mold prior to the injection molding process.

2. The method according to claim 1, wherein the carrier film is accurately positioned in the injection mold by alignment structures incorporated in the shaping surface of the injection mold.

3. The method according to claim 2, wherein the shaping surface has a flat recess incorporated therein having a shape corresponding to the outer contour of the carrier film, and the carrier film is inserted into the recess.

4. The method according to claim 3, wherein the depth of the recess corresponds to a fraction of the thickness of the carrier film.

5. The method according to claim 2, wherein the shaping surface has at least one stop incorporated therein and the carrier film is aligned by means of this stop.

6. The method according to claim 5, wherein the stop is made in the form of a step.

7. The method according to claim 1, wherein the carrier film is made to have an opening and the opening is arranged in alignment with the runner of the injection mold so that in the injection molding process the composition that is injected traverses the opening.

8. The method according to claim 1, wherein the carrier film is preformed before being inserted into the injection mold.

9. A syringe body, produced by the method of claim 1.

10. An injection mold for producing a syringe body by an injection molding process, said mold having a shaping surface, said shaping surface having a flat recess incorporated therein, an injection opening disposed in the flat recess, said recess having an outer contour shaped to correspond to the outer contour of a carrier film which is inserted into the flat recess prior to the injection molding process.
